(19) United States
(12) Patent Application Publication
(10) Pub. No.: US 2023/0255856 A1
(43) Pub. Date: Aug. 17, 2023

(54) PACIFIER ASSEMBLY

(71) Applicant: MorePeas LLC, Seattle, WA (US)

(72) Inventors: Allison Jane Fadden, Seattle, WA (US); Jessica Lyne Severt, Seattle, WA (US); Adam Abraham Jossem, Seattle, WA (US)

(21) Appl. No.: 18/168,993

(22) Filed: Feb. 14, 2023

Related U.S. Application Data
(60) Provisional application No. 63/311,404, filed on Feb. 17, 2022.

(51) Int. Cl. A61J 17/00; A61J 17/02

(52) U.S. Cl. CPC A61J 17/10; A61J 17/001; A61J 17/02; A61J 17/1115; A61J 17/113

(57) ABSTRACT

A pacifier and teething toy assembly includes a shield and a pacifier removably and reversibly coupled to the shield. The shield includes a collar and a first channel for receiving a ridge of a base plate of the pacifier. The shield further includes at least one opening through the shield and a second channel in communication with the at least one opening. The pacifier includes a nipple that is manipulatable or foldable between an extending use position and a collapsed storage position. In the storage position, an exposed portion of the nipple is received in a cavity in the shield to protect the nipple from external contaminants. The pacifier also includes at least one opening and a channel in communication with the at least one opening. The openings and channels of the shield and pacifier cooperate to define an air path through the assembly.

### BACKGROUND

### Technical Field

The present disclosure is directed to a pacifier and is particularly, but not exclusively, directed to a pacifier with a protective shield.

### Description of the Related Art

Pacifiers are known. A typical pacifier includes a nipple intended to soothe a crying child, among other potential benefits. However, known pacifiers suffer from a number of disadvantages. For example, dropping a known pacifier or storing a known pacifier in an unsanitary environment when the pacifier is not in use can each result in the nipple coming into contact with external contaminants that must be properly cleaned before the pacifier is safe to use again. If the pacifier is not cleaned, then the contaminants may be unpleasant or harmful to the infant in some cases. Further, known pacifiers do not assist with teething issues and are therefore an incomplete solution for soothing infants. It would therefore be advantageous to have a pacifier that overcomes the disadvantages of known pacifiers.

### BRIEF SUMMARY

One or more embodiments of a pacifier assembly according to the present disclosure may be summarized as including: a protective cover, including a base, a collar coupled to the base and extending from the base around a perimeter of the base, a first channel in the collar, at least one hole through the base, a second channel in the base in communication with the at least one hole, a protrusion extending from the base, a cavity in the protrusion, a handle coupled to the base, and a plurality of bumps on the handle; and a pacifier removably coupleable to the protective cover, including a base having a rim structured to be removably received in the first channel in the collar of the protective cover, a nipple coupled to the base, at least one hole in the base, and a channel in the base in communication with the at least one hole in the pacifier, the pacifier being manipulatable between a use position and a storage position, the nipple extending away from the base of the pacifier in the use position and the nipple collapsed and receivable in the cavity in the protrusion of the protective cover in the storage position, and the at least one hole through the base of the protective cover, the first channel in the collar of the protective cover, the at least one hole in the base of the pacifier, and the channel in the base of the pacifier cooperating to define an airflow path.

The assembly may further include: the base of the pacifier further including a first surface and a second surface opposite to the first surface, the nipple coupled to the first surface of the base of the pacifier, and wherein the pacifier is invertible between the use position and the storage position with the first surface of the base of the pacifier spaced from the base of the protective cover across a thickness of the base in the use position and the first surface of the base of the pacifier adjacent to the base of the protective cover in the storage configuration; the collar of the protective cover further including a ridge extending from the collar, an outermost surface of the protective cover defined by the ridge; the nipple having a sidewall with a first thickness and a second thickness, the first thickness being different than the second thickness; a lanyard removably coupled to the handle of the protective cover; and the collar of the protective cover further including a ridge extending from the collar, the ridge extending beyond the pacifier in the storage position.

One or more embodiments of a pacifier assembly may be summarized as including: a shield including a channel and at least one opening through the shield in communication with the channel of the shield; and a pacifier removably coupleable to the shield, the pacifier including a channel and at least one opening through the pacifier in communication with the channel of the pacifier, the pacifier further including a nipple being manipulatable between a use position and a storage position, the nipple extending from the pacifier in the use position and being collapsed in the storage position, the shield structured to receive at least a portion of the nipple internal to the shield in the storage position of the nipple, the at least one opening through the cover, the channel in the cover, the at least one opening in the pacifier, and the channel in the pacifier cooperating to define an airflow path.

The pacifier assembly may further include: the channel of the shield being a first channel, the shield further including a base, a collar extending from the base, and a second channel in the collar, the pacifier further including an outer rim receivable in the second channel of the collar of the shield; the shield including a central protrusion with a hollow dome shape structured to receive the at least the portion of the nipple internal to the shield in the storage position; the shield further including a handle with a plurality of teething bumps on the handle; the pacifier including a base plate with the nipple coupled to the base plate, the at least the portion of the nipple extending from the base plate in the storage position; a lanyard removably coupled to the shield; and an outermost surface of the shield extending beyond an outermost surface of the pacifier with the nipple in the storage position to prevent the pacifier from contacting an external environment or an external surface.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive embodiments are described with reference to the following drawings, wherein like labels refer to like parts throughout the various views unless otherwise specified. The sizes and relative positions of elements in the drawings are not necessarily drawn to scale in some figures. For example, the shapes of various elements are selected, enlarged, and positioned to improve drawing legibility. In other figures, the sizes and relative positions of elements in the drawings are exactly to scale. The particular shapes of the elements as drawn may have been selected for ease of recognition in the drawings. The figures do not describe every aspect of the teachings disclosed herein and do not limit the scope of the claims.

FIG. 1 is a top isometric view of an embodiment of an assembly including a shield and a pacifier in a use position according to the present disclosure.

FIG. 2 is bottom isometric view of the assembly of FIG. 1.

FIG. 3 is an exploded isometric view of the assembly of FIG. 2.

FIG. 4 is a diametric cross-sectional view of the assembly along line A-A of FIG. 1.

FIG. 5 is a top isometric view of the shield of the assembly of FIG. 1.

FIG. 6 is a bottom isometric view of the shield of FIG. 5.

FIG. 7 is a diametric cross-sectional view of the shield along line B-B of FIG. 5.

FIG. 8 is a top isometric view of the pacifier of the assembly of FIG. 1 in the use position.

FIG. 9 is a bottom isometric view of the pacifier of FIG. 8.

FIG. 10 is a diametric cross-sectional view of the pacifier along line C-C in FIG. 8.

FIG. 11 is a top isometric view of the pacifier of the assembly of FIG. 1 in a storage position.

FIG. 12 is a bottom isometric view of the pacifier of FIG. 11.

FIG. 13 is an isometric cross-sectional view of the pacifier along line D-D in FIG. 11.

FIG. 14 is a bottom isometric view of the assembly of FIG. 1 with the pacifier in the storage position and received in the shield.

FIG. 15 is a diametric cross-sectional view of the assembly in the storage position along line E-E of FIG. 14.

FIG. 16A is an isometric view of an embodiment of a lanyard according to the present disclosure.

FIG. 16B is a detail view of a handle of the lanyard of FIG. 16A coupled to the handle of the pacifier assembly of the present disclosure.

FIG. 17 is an array of different nipple configurations for the pacifier of the present disclosure.

### DETAILED DESCRIPTION

Persons of ordinary skill in the art will understand that the present disclosure is illustrative only and not in any way limiting. Other embodiments of the presently disclosed system and method readily suggest themselves to such skilled persons having the assistance of this disclosure.

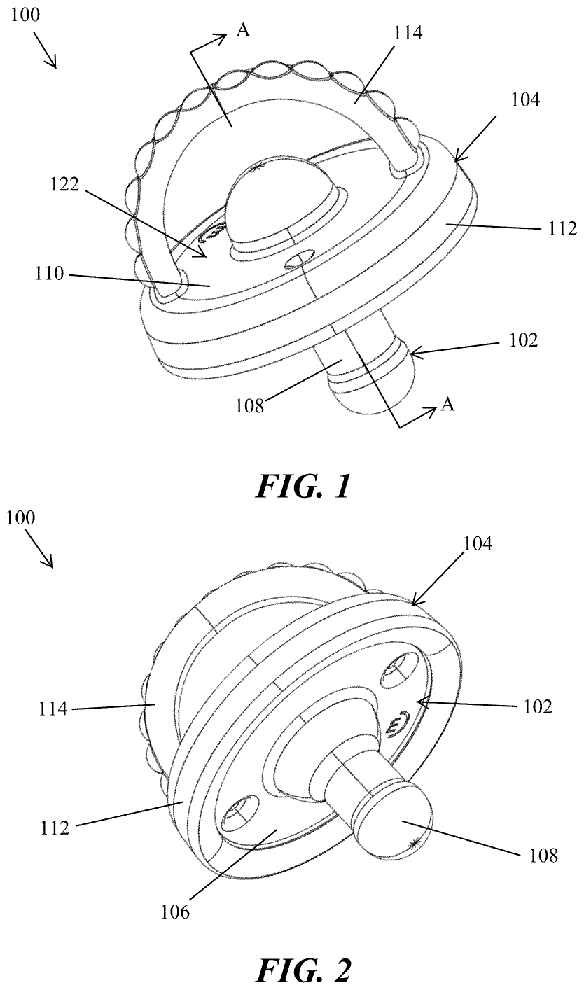

Each of the features and teachings disclosed herein can be utilized separately or in conjunction with other features and teachings to provide pacifier devices, systems, and methods. Representative examples utilizing many of these additional features and teachings, both separately and in combination, are described in further detail with reference to attached FIGS. 1-16. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present devices, systems and methods. However, it will be apparent to one skilled in the art that these specific details are not required to practice the teachings of the present devices, systems and methods.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced, but are not intended to limit the dimensions and the shapes shown in the examples in some embodiments. In some embodiments, the dimensions and the shapes of the components shown in the figures are exactly to scale and intended to limit the dimensions and the shapes of the components.

The present disclosure is generally directed to a pacifier assembly that includes a pacifier and a shield or protective cover that overcomes the above disadvantages of known pacifiers described above. The pacifier has a nipple that is foldable or collapsible for storage inside the shield when not in use to protect the pacifier and nipple from external contaminants. In use, the nipple extends from the pacifier while holes and channels in the shield enable airflow through the assembly. Further, the shield may include a handle with teething bumps that also enables the pacifier assembly to be attached to an external structure with a lanyard.

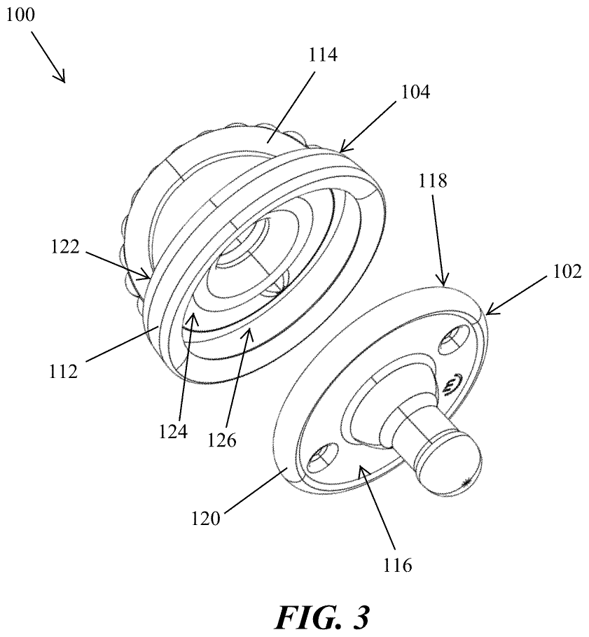

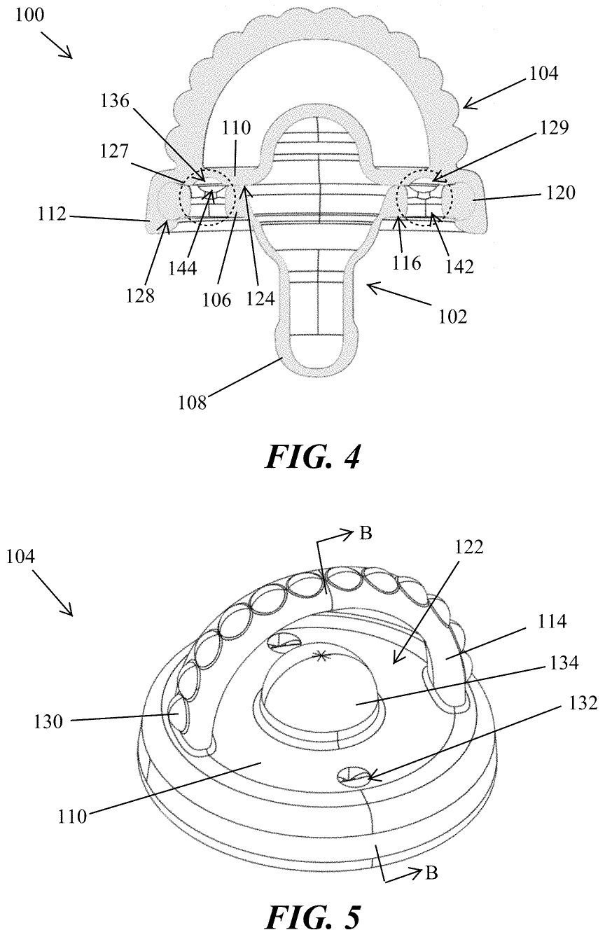

FIGS. 1-4 are various views of one or more embodiments of a pacifier assembly 100 in a use position. The assembly 100 is illustrated in FIG. 1 and FIG. 2 in a top and bottom isometric view, respectively. FIG. 3 is an exploded view of the pacifier 100 and FIG. 4 is a cross-sectional view of the pacifier 100.

Beginning with FIG. 1 and FIG. 2, the assembly 100 includes a pacifier 102 and a pacifier shield 104 (which may also be referred to herein as a shield 104 or a cover 104). The pacifier 102 is removably coupled to the shield 104 and manipulatable between the use position shown in FIGS. 1-4 and a storage position described further below with reference to FIGS. 11-15. The pacifier 102 includes a base or base plate 106 and a nipple 108 coupled to, and extending from, the base 106 in the use position. The shield 104 includes a base or base plate 110 and a collar 112 coupled to the base 110 of the shield 104. The collar 112 extends around a perimeter of the base 110 of the shield 104 to define a cavity 126 (FIG. 3) for receiving the base 106 of the pacifier 102. The shield 104 may also include a handle 114 coupled to the base 110 of the shield 104 that will be described in additional detail below.

Turning to FIG. 3, the base 106 of the pacifier 102 has a first surface 116 and a second surface 118 opposite the first surface 116. The nipple 108 is coupled to the first surface 116 of the base 106 with the first surface 116 generally being flat and planar or slightly rounded to facilitate use of the pacifier 102 and the nipple 108, except for an enlarged rim 120 extending from the first surface 116 and the second surface 118 around a perimeter of the base 106 of the pacifier 102. The base 110 of the shield 104 similarly has a first surface 122 and a second surface 124 opposite the first surface 122 with the handle 114 of the shield 104 coupled to the first surface 122. The collar 112 of the shield 104 extends from the first surface 122 past the second surface 124 of the base 110 of the shield 104 to define the cavity 126 for receiving the base 106 of the pacifier 102 to removably couple the pacifier 102 to the shield 104 and complete the assembly 100. As best shown in FIG. 1, the first surface 122 of the base 110 of the shield 104 may be flat and planar in some embodiments to provide an aesthetically pleasing outward appearance.

FIG. 4 illustrates that the ridge 120 of the base 106 of the pacifier 102 is received in a corresponding cavity 128 in the collar 112 of the shield 104 to removably couple the pacifier 102 to the shield 104, such as through a friction fit. In some embodiments, the pacifier 102 and the shield 104 are silicone, such that the collar 112 is flexible. Thus, the user can manipulate the collar 112 to insert or remove the ridge 120 of the base 106 of the pacifier 102 in the cavity 128 in the collar 112 of the shield 104. In addition, the nipple 108 of the pacifier 102 may be hollow in some embodiments to enable the child to gum or chew the nipple 108. FIG. 4 also illustrates an airflow path 127 through the assembly 100 that is highlighted by dashed circles. The airflow path 127 will be described in additional detail herein.

FIGS. 5-7 are various views of the shield 104 of the assembly 100 described above. Beginning with FIG. 5, the handle 114 of the shield 104 includes a plurality of teething bumps 130. Specifically, the bumps 130 may be arranged in a single row across an entirety of a length or circumference of the handle 114 with each bump 130 in contact with the next successive bump 130 to create a continuous series of teething bumps 130. As shown in FIG. 5, the bumps 130 may have a rounded or hemispherical shape. In one or more embodiments, the bumps 130 may have any selected shape and configuration, including an irregular shape and spacing, a bow shape, a braided or knot design, or the bumps 130 may be a plurality of teeth or splines, among many other options suitable for use as a teething toy. Further, the shield 104 includes at least one hole 132 through the base 110 from the first surface 122 to the second surface 124 (FIG. 3) of the shield 110 as well as a protrusion 134 in the shape of a dome extending from the first surface 122 of the base 110. In some embodiments, the shield 104 includes two holes 132 through the base 110 arranged on opposite sides of the protrusion 134.

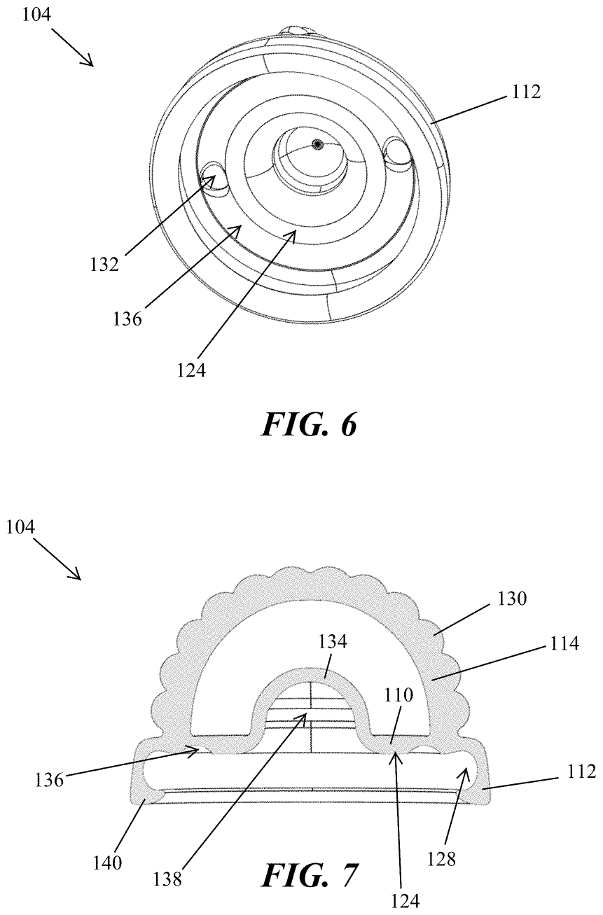

FIG. 6 is a bottom isometric view of the shield 104 illustrating that the holes 132 through the base 110 (FIG. 5) of the shield 104 are in communication with a channel 136 in the second surface 124 of the base 110. In some embodiments, the channel 136 extends around an entirety of the base 110 of the shield 104 proximate, or adjacent to, an interface between the second surface 124 of the base 110 and the collar 112 of the shield 104.

FIG. 7 is a cross-sectional view along a vertical plane through the handle 114 of the shield 104. In some embodiments, the bumps 130 on the handle 114 are solid silicone to provide relief for teething children. Further, a cavity 138 extends into the protrusion 134 (i.e., the protrusion 134 is hollow) in order to receive the nipple 108 of the pacifier 102 in the storage position described in more detail below. FIG. 7 further shows the channel 128 in the collar 112 in additional detail. In some embodiments, the collar 112 of the shield 104 includes a ridge 140 extending from the collar 112 to define an outermost surface of the shield 104. The ridge 140 extends at least partially into the cavity 128 in the collar 112 to assist with securing the pacifier 102. In addition, the ridge 140 provides a protective edge that spaces the pacifier 102 from an external surface if the assembly 100 is dropped, as explained further below. FIG. 7 also illustrates the channel 136 in the second surface 124 of the base 110 of the shield 104 in more detail. In particular, the holes 132 and the channel 136 cooperate to define an airflow path through the shield 104.

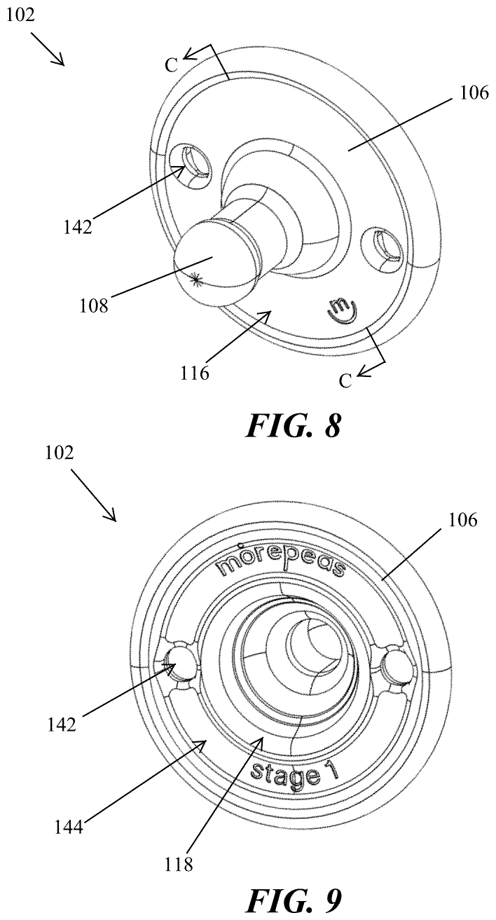

FIGS. 8-10 are various views of the pacifier 102 in the use position. With reference to FIG. 8 and FIG. 9, the pacifier 102 includes at least one hole 142 through the base 106 of the pacifier 102 in some embodiments. In particular, the pacifier 102 may include two holes 142 positioned on opposite sides of the nipple 108 that extend through the base 106 from the first surface 116 to the second surface 118. The holes 142 are in communication with a channel 144 in the base 106 of the pacifier 102 to define an airflow path through the pacifier 102.

The airflow path through the pacifier 102 cooperates with the airflow path through the shield 104 described with reference to FIG. 7 to define an airflow path 127 through the assembly 100 best shown by the dashed circles in FIG. 4. Beginning with FIG. 4, and with continuing reference to FIGS. 6-9, the airflow path 127 through the assembly 100 is a combination of the holes 132 and the channel 136 in the shield 104 and the holes 142 and the channel 144 in the base 106 of the pacifier 102. As shown in FIG. 6, the channel 136 in the shield 104 extends around an entire circumference of the shield and is in fluid communication with the holes 132 in the shield 104. Similarly, the channel 144 in the pacifier 102 extends around an entire circumference of the pacifier 102 and is in fluid communication with the holes 142 in the pacifier 102 as in FIG. 9.

When the pacifier 102 is coupled to the shield 104 in the use position shown in FIG. 4, the channels 136, 144 align and cooperate to define a generally enclosed space 129 extending internally around the assembly 100. The holes 132 (FIG. 5) in the shield 104 face away from the user and the holes 142 in the pacifier 102 face the user with the holes 132, 142 in communication with the enclosed space 129 defined by the channels 136, 144 to provide inlets and outlets to complete the airflow path 127. More specifically, air can flow into the holes 132, 142, through the enclosed space 129, and out of the holes 132, 142 in the airflow path 127. The airflow path 127 through the assembly 100 prevents a vacuum from forming during use while also reducing safety risks in the event the assembly 100 is swallowed or otherwise blocks or restricts a user's ability to breathe during use.

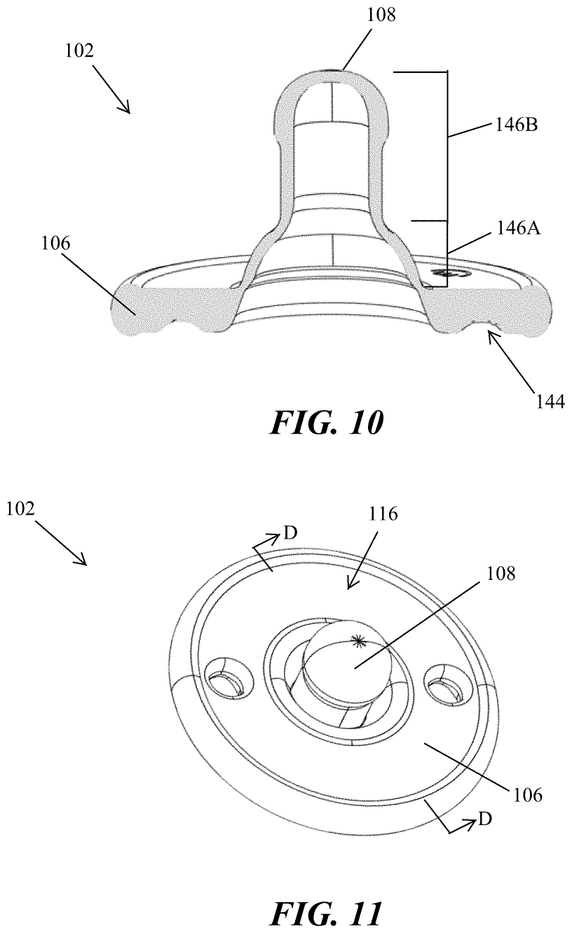

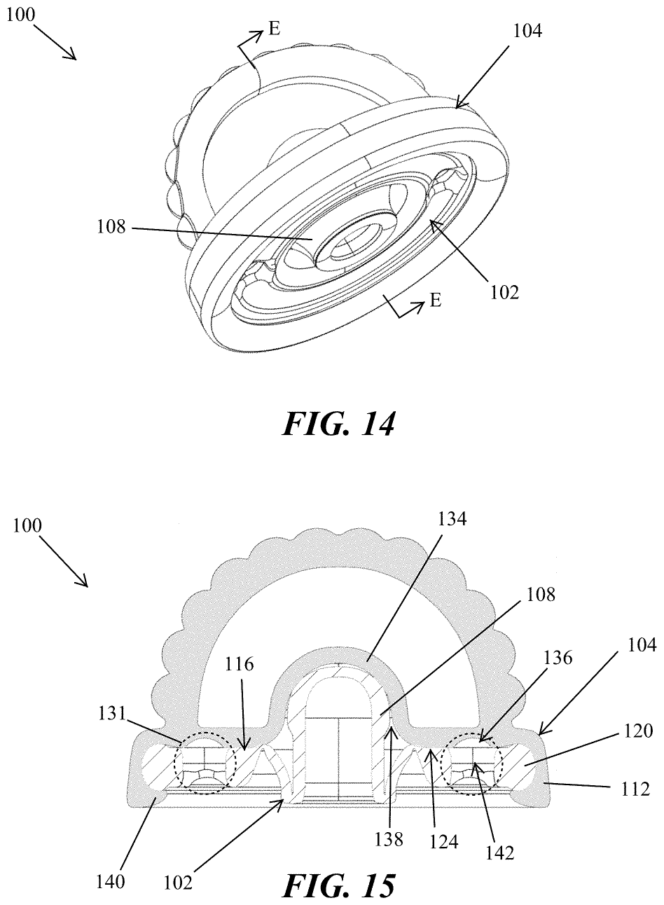

FIG. 10 is a cross-sectional view of the pacifier 102 along a vertical plane through a center of the nipple 108. FIG. 10 illustrates the channel 144 in the base 106 of the pacifier 102 in more detail. When the pacifier 102 is coupled to the shield 104, as in FIGS. 1-4 in the use position and in FIGS. 14-15 in the storage position, the channel 144 and the holes 142 in the base 106 of the pacifier 102 cooperate with the channel 136 and the holes 132 in the base 110 of the shield 104 to define an airflow path through the assembly 100. The airflow path enables a child to suck on the nipple 108 without creating a vacuum against the child's face during use. Further, the airflow path through the assembly 100 improves the safety of the assembly 100 by enabling a child to continue breathing even if swallowing the assembly 100 or otherwise having the assembly 100 in their mouth. The same is true of the airflow path through each component of the assembly 100, namely the pacifier 102 and the shield 104. Each of the pacifier 102 and the shield 104 include an airflow path, as described above, which provides similar advantages.

Further, FIG. 10 shows that the nipple 108 may have a base portion 146A integral with a nipple portion 146B as a single unitary component. The base portion 146A is coupled to the base 106 of the pacifier 102 and includes a diameter and a thickness. The nipple portion 146B likewise includes a diameter and a thickness. In some embodiments, the base portion 146A has a larger diameter proximate the base 106 of the pacifier 102 than the nipple portion 146B. However, the diameter of the base portion 146A tapers over the height of the base portion 146A to transition to the nipple portion 146B. In addition, a thickness of the nipple 108 at the base portion 146A may be less than a thickness of the nipple 108 in the nipple portion 146B to enable the base portion 146A of the nipple 108 to bend and fold between the use position shown in FIG. 10 and the storage position shown in FIGS. 11-13.

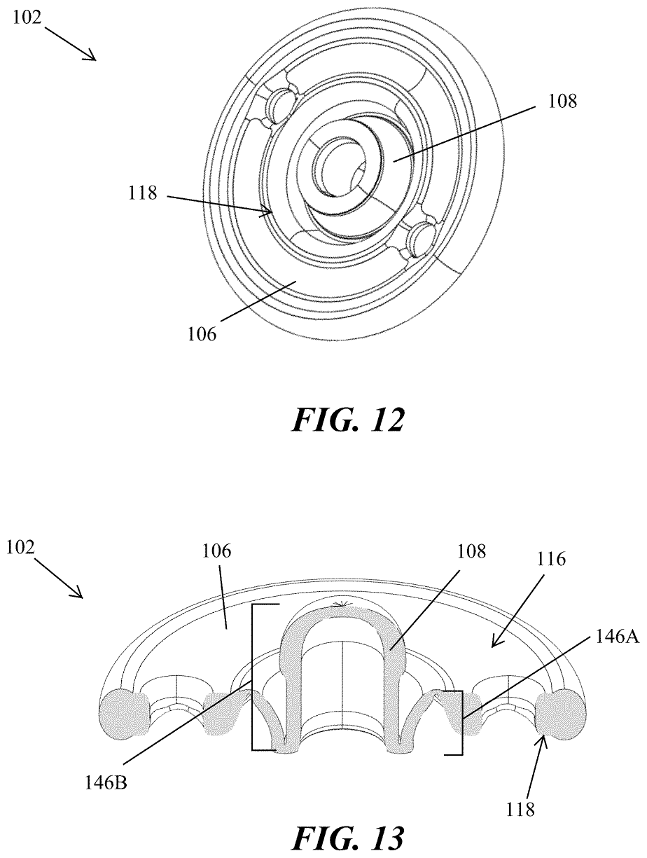

FIGS. 11-13 are various views of the pacifier 102 in a storage position. In the storage position, the base portion 146B (FIG. 10) of the nipple 108 is collapsed or folded to reduce a height of the nipple relative to the base 106 of the pacifier 102 as shown in FIG. 11. The base portion 146B (FIG. 10) of the nipple 108 may also be planar with, or extend beyond the second surface 118 of the base 106 of the pacifier 102 in the storage position as in FIG. 12. Turning to FIG. 13, the base portion 146A of the nipple 108 may overlap the nipple portion 146B in the storage position. In one or more embodiments, the nipple portion 146B overlaps a portion of, a majority of, substantially all, or all of, the base portion 146A of the nipple 108 in the storage position of the pacifier 102.

FIGS. 14-15 are various views of the assembly 100 in a storage position. In the storage position, the pacifier 102 is entirely received within the cavity 126 in the shield 104 with the nipple 108 inverted, as shown in FIG. 14. In particular, the inverted nipple 108 is at least partially received in the cavity 138 in the protrusion 134 of the shield 104 as shown in FIG. 15, to protect the nipple 108 from contacting external contaminants if the assembly 100 is dropped or placed in an unsanitary storage location. Further, the ridge 140 of the collar 112 of the shield 104 extends beyond an outermost surface of the pacifier 102 (such as a bottom surface of the nipple 108 or the second surface 118 of the pacifier 102) to prevent the pacifier 102 from contacting flat surfaces if the assembly 100 is dropped and rests on the ridge 140.

In use, and with reference to FIG. 4 and FIG. 15, the assembly 100 may initially be in the storage position shown in FIG. 15. The user, which may be a parent or other caregiver, removes the pacifier 102, which is initially in the storage position, from the shield 104. The user can then apply a force to the bottom of the nipple 108 to extend the nipple 108 to the use position shown in FIG. 4. The user inverts the pacifier 102 and couples the pacifier 102 to the shield 104 to complete the assembly shown in FIG. 4. To return the assembly 100 to the storage position in FIG. 15 after use, the above steps are repeated in reverse, namely removing the pacifier 102 from the shield 104, folding or collapsing the nipple 108, inverting the pacifier 102 and inserting it into the shield 104 with the nipple 108 received in the protrusion 134 for secure storage. More specifically, “inverted” or “inverting” in the above description refers to flipping the pacifier 102 over between the use and storage positions. As shown in FIG. 4, the first surface 116 of the base 106 of the pacifier 102 is facing away from the second surface 124 of the base 110 shield 104 and spaced from the second surface 124 across the base 106 in the use position. By comparison, the first surface 116 of the base 106 of the pacifier 102 is proximate to, adjacent to, or in abutting contact with the second surface 124 of the shield 104 in the storage position shown in FIG. 15.

In some embodiments, the nipple 108 may have a fold design that does not require the pacifier 102 to be disassembled from the shield 104 between the use and storage positions. Rather, the protrusion 134 may be flexible with the fold in the nipple 108 having a different arrangement to that shown in FIG. 15 that enables the nipple 108 to extend from the pacifier 102 in response to the user pressing on the protrusion 134 of the shield 104.

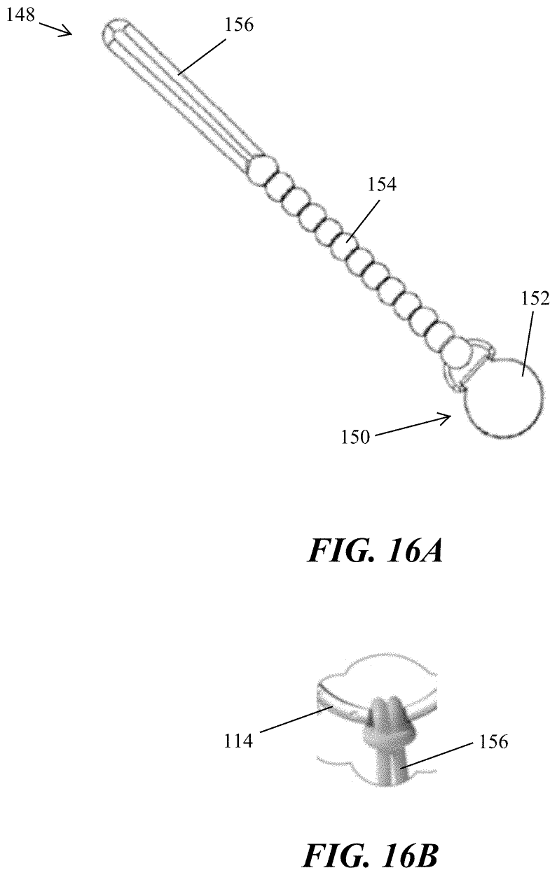

In view of the above, the pacifier assembly 100 keeps the entire nipple 108 clean when not in use because the pacifier 102 is inverted and the nipple 108 is stored completely internal to the shield 104, and specifically within the protrusion 134 of the shield 104. Thus, the pacifier assembly 100 can be used as a teething ring with the nipple 108 in the storage position, as in FIG. 15, to reduce the likelihood that the nipple 108 will contact external contaminants if the assembly 100 is dropped during use as a teething ring. As described further below with reference to FIG. 16, a lanyard can be used with the assembly 100 to reduce the likelihood that the pacifier will be dropped in the use position.

FIG. 15 also illustrates an airflow path 131 through the assembly 100 in the storage position highlighted by dashed lines. The airflow path 131 includes the holes 132 (FIG. 6) and the channel 136 in the shield 104 as well as the holes 142 through the pacifier 102. When the pacifier 102 is coupled to the shield 104 in the storage position as in FIG. 15, the pacifier 102 generally closes the open side of the channel 136 in the shield 104, except the holes 132 in the shield 104 and the holes 142 in the pacifier 102 remain in communication with the channel 136 in the shield 104. As a result, air can flow into the holes 132, 142, through the channel 136 in the shield 104, and out of the holes 132, 142. As a result, the airflow path 131 through the assembly 100 in the storage position reduces safety risks in the event the assembly 100 is swallowed or otherwise blocks or restricts a user's ability to breathe while in the storage position.

FIG. 16A is an isometric view of a lanyard 148 that may be coupled to the assembly 100. The lanyard 148 may include one or more securing mechanisms 150, such as a clasp, hook and loop fasteners, a button, a buckle, or other like device in some non-limiting examples. The securing mechanism 150 may have a lever plate 152 for supporting the clasp or other securing structure. The clasp or securing structure can be attached to a number of different external items, such as a child's clothing, a baby carrier, a stroller, or a car seat in some non-limiting examples. The lanyard 148 may also include a plurality of interconnected silicone structures 154 coupled to the securing mechanism 150 and terminating in a smooth handle 156. The structures 154 may have a spherical or hemispherical shape, as well as any shape described above with reference to the teething bumps 130 in FIG. 5. Other configurations for the lanyard 148 are also contemplated herein.

FIG. 16B is a detail view of the handle 156 of the lanyard 148 of FIG. 16A attached to the handle 114 of the pacifier assembly 100 described herein, such as with a slip knot in one non-limiting example. Other attachment mechanisms for securing the handle 156 of the lanyard 148 to the handle 114 of the assembly 100 are contemplated herein, including but not limited to snaps, hook and loop fasteners, clasps, and other like devices. Thus, the lanyard 148 reduces the risk of dropping the assembly 100 by enabling the assembly 100 to be tethered to an external support structure.

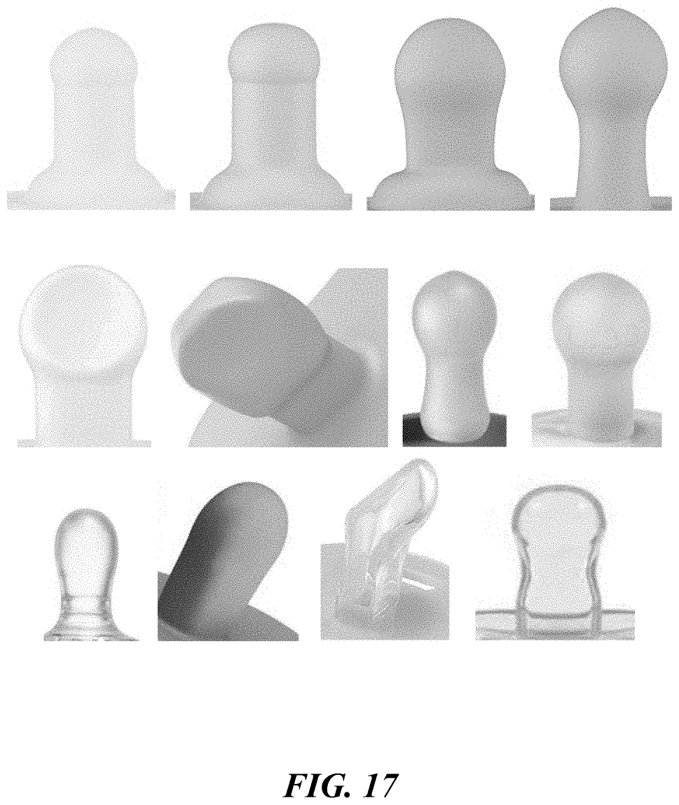

FIG. 17 is a photograph array of different nipple configurations for the pacifier 102 of the assembly 100. Although FIGS. 1-16 provide one non-limiting example of a nipple design for the pacifier 102, it is contemplated herein to use any number of different nipples 108 with the pacifier 102 with a selected material, size, shape, hardness, and other characteristics. For example, in some embodiments, any of the nipples illustrated in FIG. 17 may replace nipple 108, in addition to other designs. Accordingly, the present disclosure is not limited to the specific design of the nipple 108.

Thus, the present disclosure provides for a pacifier assembly that includes a pacifier and a shield or protective cover that overcomes the above disadvantages of known pacifiers described above. The pacifier has a nipple that is foldable or collapsible for storage inside the shield when not in use to protect the pacifier and nipple from external contaminants. In use, the nipple extends from the pacifier while holes and channels in the shield enable airflow through the assembly. Further, the shield may include a handle with teething bumps to provide dual functionality while also enabling the pacifier assembly to be attached to an external structure with a lanyard.

In the above description, certain specific details are set forth in order to provide a thorough understanding of various embodiments of the disclosure. However, one skilled in the art will understand that the disclosure may be practiced without these specific details. In other instances, well-known structures associated with pacifiers and pacifier shields have not been described in detail to avoid unnecessarily obscuring the descriptions of the embodiments of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a die may refer to one die. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other derivatives thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the present disclosure.

Generally, unless otherwise indicated, the materials for making the invention and/or its components may be selected from appropriate materials such as silicone, composite materials, plastic, polymers, plastic compounds, and the like.

The foregoing description, for purposes of explanation, uses specific nomenclature and formula to provide a thorough understanding of the disclosed embodiments. It should be apparent to those of skill in the art that the specific details are not required in order to practice the invention. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “left,” “right,” and other like derivatives are used only for discussion purposes based on the orientation of the components in the Figures of the present disclosure. These terms are not limiting with respect to the possible orientations explicitly disclosed, implicitly disclosed, or inherently disclosed in the present disclosure and unless the context clearly dictates otherwise, any of the aspects of the embodiments of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various embodiments described herein, and as such, it is expressly contemplated in the present disclosure to include dimensions that are more or less than the dimensions stated, unless the context clearly dictates otherwise.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above-described embodiments, but should be defined only in accordance with the following claims and their equivalents.

1. A pacifier and teething toy assembly, including:
a protective cover, including:
a base;
a collar coupled to the base and extending from the base around a perimeter of the base;
a first channel in the collar;
at least one hole through the base;
a second channel in the base in communication with the at least one hole of the protective cover;
a protrusion extending from the base;
a cavity in the protrusion;
a handle coupled to the base; and
a plurality of bumps on the handle to form a teething toy; and
a pacifier, including:
a base having a rim structured to be removably received in the first channel in the collar of the protective cover to removably and reversibly couple the pacifier to the protective cover;
a nipple coupled to the base of the pacifier;
at least one hole in the base of the pacifier; and
a channel in the base of the pacifier in communication with the at least one hole of the pacifier,
the pacifier being manipulatable between a use configuration and a storage configuration, the nipple oriented away from the base of the protective cover and extending outward from the base of the pacifier in the use configuration, and the nipple oriented toward the base of the protective cover, collapsed with respect to the base of the pacifier, and at least partially received in the cavity in the protrusion of the protective cover in the storage configuration, and
the at least one hole through the base of the protective cover, the first channel in the collar of the protective cover, the at least one hole in the base of the pacifier, and the channel in the base of the pacifier cooperating to define an airflow path from one side of the assembly to another side of the assembly.

2. The assembly of claim 1, wherein the base of the pacifier further includes a first surface and a second surface opposite to the first surface, the nipple coupleable to the first surface of the base of the pacifier, and
wherein the pacifier is invertible between the use configuration and the storage configuration with the first surface of the base of the pacifier spaced from the base of the protective cover across a thickness of the base of the pacifier in the use position and the first surface of the base of the pacifier adjacent to the base of the protective cover in the storage configuration.

3. The assembly of claim 1, wherein the collar of the protective cover further includes a ridge extending from the collar, an outermost surface of the protective cover defined by the ridge.

4. The assembly of claim 1, wherein the nipple has a sidewall with a first thickness and a second thickness, the first thickness being different than the second thickness.

5. The assembly of claim 1, further comprising:
a lanyard removably coupled to the handle of the protective cover.

6. The assembly of claim 1, wherein the collar of the protective cover further includes a ridge extending from the collar, the ridge extending beyond the pacifier in the storage configuration.

7. A pacifier assembly, including:
a shield including a hollow protrusion; and
a pacifier removably coupleable to the shield, the pacifier including a nipple being manipulatable between a use position and a storage position, the nipple extending outward from the pacifier in the use position and being at least partially collapsed into the pacifier in the storage position, the shield structured to receive at least a portion of the nipple internal to the hollow protrusion of the shield in response to the nipple being in the storage position.

8. The assembly of claim 7, wherein the shield further includes a base, a collar extending from the base, and a channel in the collar, and the pacifier further includes an outer rim receivable in the channel of the collar of the shield to removably and reversibly couple the pacifier to the shield.

9. The assembly of claim 7, wherein the shield further includes a handle with a plurality of teething bumps on the handle.

10. The assembly of claim 7, wherein the pacifier includes a base plate with the nipple coupled to the base plate, the at least the portion of the nipple extending from the base plate in the storage position.

11. The assembly of claim 7 further comprising:
a lanyard removably coupled to the shield.

12. The assembly of claim 7, wherein an outermost surface of the shield extends beyond an outermost surface of the pacifier with the nipple in the storage position to prevent the pacifier from contacting an external environment or an external surface.

13. The assembly of claim 7, wherein the shield includes a first channel and at least one opening through the shield in communication with the first channel of the shield,
wherein the pacifier includes a second channel and at least one second opening through the pacifier in communication with the second channel of the pacifier, and
wherein the at least one first opening through the shield, the first channel in the shield, the at least one second opening in the pacifier, and the second channel in the pacifier cooperate to define an airflow path through the pacifier assembly.

14. A pacifier and teething toy assembly, including:
a protective cover, including:
a base;
at least one hole through the base;
a first channel in the base of the protective cover in communication with the at least one hole of the protective cover; and
a pacifier removably and reversibly coupleable to the protective cover, including:
a base;
a nipple coupled to the base of the pacifier;
at least one hole in the base of the pacifier; and
a second channel in the base of the pacifier in communication with the at least one hole of the pacifier,
wherein the at least one hole through the base of the protective cover, the first channel in the collar of the protective cover, the at least one hole in the base of the pacifier, and the second channel in the base of the pacifier cooperate to define an airflow path from one side of the assembly to another side of the assembly.

15. The pacifier and teething toy assembly of claim 14, wherein the protective cover further includes a handle coupled to the base of the protective cover and a plurality of bumps on the handle to form a teething toy.

16. The pacifier and teething toy assembly of claim 14, wherein the protective cover further includes a protrusion extending from the base of the protective cover having a hollow interior,
wherein the pacifier is manipulatable between a use configuration and a storage configuration, the nipple oriented away from the base of the protective cover and extending outward from the base of the pacifier in the use configuration, and the nipple oriented toward the base of the protective cover, at least partially collapsed with respect to the base of the pacifier, and at least partially received in the hollow interior of the protrusion of the protective cover in the storage configuration.

17. The pacifier and teething toy assembly of claim 14, wherein the protective cover further includes a collar coupled to the base and extending around a perimeter of the base of the protective cover and a third channel in the collar, and
wherein the base of the pacifier further includes a rim structured to be removably received in the third channel in the collar of the protective cover to removably and reversibly couple the pacifier to the protective cover.

18. The pacifier and teething toy assembly of claim 14, wherein the nipple of the pacifier includes a base portion and a nipple portion, the base portion of the nipple having a diameter that is greater than a diameter of the nipple portion.

19. The pacifier and teething toy assembly of claim 14, wherein the nipple of the pacifier includes a base portion and a nipple portion, the base portion having a thickness that is less than a thickness of the nipple portion.

20. The pacifier and teething toy assembly of claim 14, wherein the nipple of the pacifier has a reduced thickness proximate an interface between the nipple and the base of the pacifier relative to a remainder of the nipple to enable the nipple to be at least partially collapsible and receivable in a hollow portion of the protective cover.
